(19) United States
(12) Patent Application Publication
(10) Pub. No.: US 2004/0186737 A1
(43) Pub. Date: Sep. 23, 2004

(54) System for increasing revenue at sporting events

(76) Inventor: Donald Gregory Roberts, Roanoke, VA (US)

Correspondence Address: PETER E ROSDEN, 1505 LONDON ROAD, CHARLOTTESVILLE, VA, 229018881

(21) Appl. No.: 10/391,089

(22) Filed: Mar. 18, 2003

(51) Int. Cl. G06F 17/60

(52) U.S. Cl. 705/1

(57) ABSTRACT

A system and method for informing attendees and participants at public, broadcast sporting events of the duration and status of broadcast-called timeouts occurring during play and for increasing the revenue of sporting venue owners and concessionaires by creating a new, valuable, frequently viewed location for displaying advertising at sporting events in conjunction with providing the aforementioned information. The system comprises a timeout counter board having a clock, at least one advertising display box and a wireless communicator. The system further comprises a remote controller for transmitting information to and receiving information from the wireless communicator.

### TECHNICAL FIELD

The subject invention relates generally to a method and system for increasing revenue derived from publicly displayed sporting events having timeouts. In particular, the method enables greater sales of advertising at such events and promotes higher concessionaire sales to attendees of such events.

### BACKGROUND OF THE INVENTION

In most broadcast sporting events, especially televised ones, there are numerous interruptions of play in order to broadcast advertisements. Sometimes, there are even interruptions for emergency and other announcements which supercede scheduled advertisements. The length of these breaks is not known to sports team coaches, to operators of concessionaire stands at the sporting event or to the fans attending the event. There is no standard length of time for timeouts, and they may occur at any time during the event. However, the length of each scheduled and elective break is known to the television producer of the event and to the individual, if there is one, who steps onto the field of play usually wearing clothing such as a red hat and red shirt to signal initiation of the break to sports participants, time keepers and fans. Furthermore, due to unanticipated events during a game, the length of scheduled breaks may themselves have to be omitted or even lengthened to account for overtime play or unusual patterns of play.

Knowledge of the length of each intermission has the following advantages: (1) it informs coaches how much time they have to make critical game-related decisions which will not only affect the game outcome but may also impact their job tenure; (2) it enables concessionaire operators to prepare for expected sales through organization and food/sale item set up and to increase their sales through increased patronage by sporting event attendees who know they have enough time to make a purchase; and (3) it permits fans to decide if they have enough time to go to a concessionaire and make one or more purchases or even to undertake other tasks such as changing a child's diapers, making a telephone call or visiting a restroom. Furthermore, if the only way to ascertain the exact status of an interruption is at a designated timeout clock, the location of the counter for that clock would become a large, new source of revenue as a result of its use as a marketable billboard display area which will be frequently viewed by those attending the sporting event and participants in it.

Methods and systems for determining when advertisements may be added to broadcast events are known. For example, the patent application to Monson et al. (2003/0023973A1) discloses a system for inserting stored ads into live online broadcast events depending on the interpretation of signals received indicating the availability of a space for the insertion of an ad. Similarly, the application to Plotnick et al. (2002/0184047A1) discloses a system and method for accessing a universal ad queue to determine when different types of ads should be displayed to subscribers so that an advertiser can create and manage an overall ad campaign. Other art discloses ways in which actions by attendees at public events can enable them to access data related to or photographs of that event. None of this known art appears to disclose a method or system for providing information regarding sporting event timeouts or for linking the provision of such information to display advertisements. In view of the various advantages which such a system can provide, there exists, therefore, a need for a system for informing attendees and others at public sporting events of the occurrence and length of timeouts during the event.

### SUMMARY OF THE INVENTION

The present invention relates to a system for providing attendees and participates at broadcast public sporting events with information about the duration and status of timeouts during such events called for by broadcasters and for increasing the revenues of concessionaires and venue owners at such events as a result of provision of timeout information. Prior to this invention, such information was not publicly accessible. The system requires a timeout counter board which includes an illuminated clock displaying a countdown of timeouts in minutes and seconds and at least one display box containing paid-for advertising which is preferably illuminated when the clock is illuminated. For each sport having timeouts, a timeout schedule is created by a broadcast producer calling for a specified number of timeouts during play of the sport. Once play has begun, the producer decides when a timeout is required and how long that timeout plus a transition back to play period should be. The timeout is initiated by remote transmission of the timeout length from a remotely located controller to a communicator which is part of the timeout counter board. That communicator primes the clock to display numerals representing the requested timeout period. Once a timeout has begun, the clock and the adjacent display box is illuminated. The countdown of the clock may rarely be interrupted for either termination or suspension but generally proceeds until the clock numerals read “0:00” at which time the clock flashes, illumination of the clock and display boxes ends and play of the sport resumes. Attendee and sport participant attention is frequently focused on the clock during the timeout in order to time various actions which each person wants to take during the known timeout period. Repeated, concentrated exposure to advertising placed in the display box results. This pattern of timeout clock illumination and advertising exposure continues until all scheduled timeouts have been taken or until the sporting event ends.

It is a primary objective of this invention to provide a system and method for conveying previously unavailable information to attendees and participants on the duration and status of timeout periods called for by broadcasters during a public sporting event.

An additional objective of this invention is to provide a system and method for increasing the revenue of owners of public sporting event venues by establishing a new, highly valuable advertising location adjacent to a clock displaying the duration and status of timeouts during a sporting event.

Another objective of this invention is to establish a new advertising location at public sporting events the value of which is increased due to the frequency with which it is viewed by attendees and participants at the sporting event.

It is a further objective of this invention to provide an efficient, relatively inexpensive system comprising a clock, at least one advertising display space for providing information to participants and attendees of a public sporting event concerning the duration and status of timeouts during the sporting event, a wireless communicator and a remote controller.

It is yet another objective of this invention to increase the revenue of concessionaires at public sporting events by encouraging attendees of such events to patronize such concessionaires by informing the attendees of when they can do so without missing any sports action.

### BRIEF DESCRIPTION OF THE DRAWINGS

The foregoing and other objects, aspects and advantages of the invention will be better understood from the following detailed description of the invention with reference to the drawings, in which:

FIG. 1 shows the assembled components of the system of the invention.

FIGS. 2A and 2B illustrate the steps taken in the method of the invention.

FIG. 3 shows a typical timeout schedule for a sporting event.

### DESCRIPTION OF THE PREFERRED EMBODIMENT OF THE INVENTION

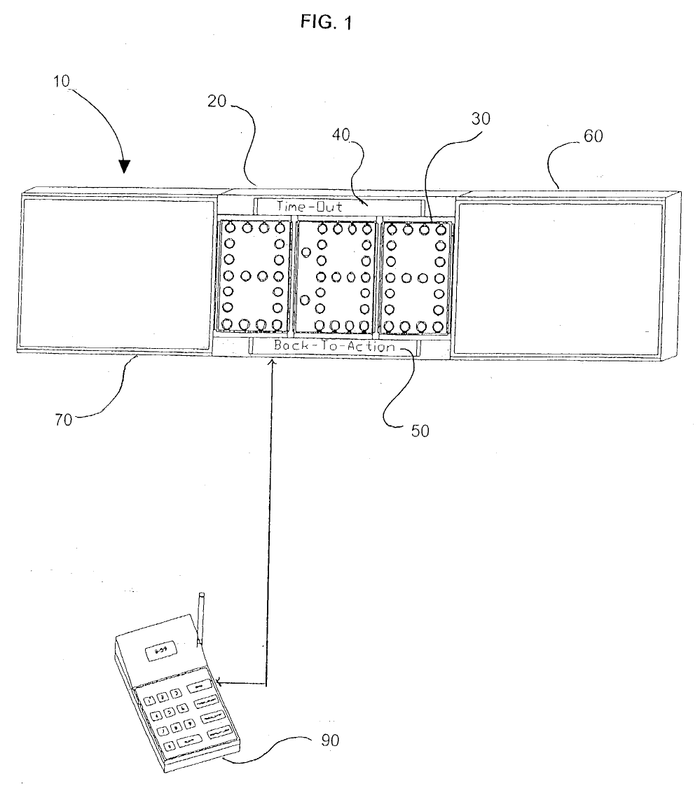

For a more detailed understanding of the invention, reference is first made to FIG. 1 of the drawings. This figure illustrates physical components of the system of the invention beginning first with timeout counter board 10 which comprises a countdown clock box 20 further including clock 30 showing time remaining in minutes and seconds and notice areas 40 and 50, a first display ad box 60 and a second display ad box 70 as these elements would appear when mounted in a sports arena or stadium during the display of a timeout countdown event.

Alternative configurations of board 10 are possible in which additional display ad boxes may be positioned above and/or below clock box 20. Including more than four display ads around clock box 20 is likely to be counterproductive since the multiplicity of ads themselves are likely to distract from the impact and effectiveness of each of the ads appearing on board 10. The display ads are preferably printed billboard type ads for one product which are imprinted on translucent, precast panels, on Plexiglas or on another suitable surface wherein one ad is mounted in each display ad box. Alternatively, the display ad boxes could be configured to operate and change electronically and/or programmably so that more than one ad would be displayed successively in the display ad boxes during the progress of a sporting event, as desired.

Board 10 is a box housing clock box 20 and display ad boxes 60 and 70. A box with dimensions of 198 inches in length, 50 inches in height and 8 inches in depth is preferred, although these dimensions can be altered to suit circumstances. The box could be constructed of 0.062 inch thick aluminum with or without mounting brackets, as preferred. Clock 30 is a remote-wireless settable, 3-digit countdown clock with a maximum setting of 9:99, or 9 minutes and 99 seconds housed within clock box 20. Clock 30 has both indoor and outdoor capability and is housed in a 74 inch long by 50 inch high display. The use of 32 inch high numerals is recommended for most stadiums, although all of these dimensions could be varied depending on the circumstances. Each digit in the clock can be represented by a 4×7 matrix of incandescent lamp units having a preferred wattage of 25 watts, although whatever wattage is desired can be used. The digits can also be formed from any other type of illumination source deemed suitable for the purpose such as fluorescent bulbs, LCD or plasma displays. The lamp matrix for each digit is covered by a clear outer sheet of Plexiglas or other suitable transparent, protective material. Clock box 20 also includes notice areas 40 and 50 which are each 9 inches high by 74 inches long. Notice area 40 is a backlit, stenciled, Plexiglas panel which draws the viewers' attention to the fact that a timeout is in progress, while notice area 50 is a backlit, stenciled, Plexiglas panel informing viewers that play has resumed. Materials other than Plexiglas may also be used for notice areas 40 and 50 so long as they are suitable for the type of illumination employed. When clock 30 is illuminated, notice area 40 is also illuminated. When clock 30 is not illuminated, i.e. during play of the sport, notice area 50 is illuminated. Each display ad box 60 and 70 is typically an advertising panel backlit by a matrix of incandescent bulbs and having dimensions of 62 inches in length, 50 inches in height and 8 inches in depth. Alternatively, the backlighting can also be provided by any other light source or front lighting could be used. Preferably, display ad boxes 60 and 70 are backlit only when the clock is in use. In this way, the audience would not become used to seeing, and therefore possibly ignoring, the display ads, whenever they turned their attention to clock 30. It is also possible to keep them lit throughout the duration of play or for any other desired time period. Similarly, the boxes could be designed so that they incorporate more than one ad, and display of the ads for each box could be rotated over whatever time schedule is preferred.

Board 10 also includes a wireless communicator 80 protectively housed within clock box 20 and not shown in FIG. 1 which will receive and acknowledge instructions to board 10 during events. It is preferably a 920 MHz wireless unit having internal printed circuit board and microprocessor technology designed to digitally transmit, receive, process and control the lamp outputs on board 10 during events. For example, a Radiometrix LTD RF component and external antennae for the communications unit could be used. Any similar unit could be used so long as it performed all of the functions described herein. Such communicators are known in the art although they do not appear to have been used for the purpose of this invention.

Board 10 can be operated in several modes. In standby or unused mode, the lamp units remain unlit. In this state, a pre-set clock count can be received by wireless communicator 80 as preparation for the start of a display on clock 30. The lamp units will remain blank until a “timer start” signal is received. The display timer will then light to display the previously received clock-count and start the countdown. When the count reaches “0:00”, the display will remain lit until either an instruction is received to enter the display off mode or, if programmed to do so, the counter will flash “0:00” three times, or any other chosen number of times, before all backlighting in the clock box and/or in the display ad boxes, if so desired, automatically turns off. A new timer count signal received by communicator 80 during the progression of a countdown will be ignored until the countdown is complete. While the lamp units are lit displaying the clock count, display ad boxes 60 and 70 will also be illuminated. These spaces will remain lit until the display off mode instruction is received or otherwise activated. When a timer stop signal is received during countdown, the lamp units will remain lit, or turn off if that option is selected, and the clock will cease its countdown. This is an extremely rare event this is not expected to occur with any degree of frequency. For example, one such event would be the premature termination of advertisements being broadcast during a break due to technical problems. In this mode, several commands can be issued. These include a timer start signal to restart the countdown, a new clock count input signal for display prior to countdown and a display-off signal which can be used to return the lamp units to standby mode with all lamp units dark. When a display-off instruction is received, the lamp units will return to standby mode. The new clock count signal is one sent from a remote device to board 10 and is meant to be received and used by communicator 80 to reset the clock countdown signal numbers and, if desired, display them prior to initiation of the actual countdown. For security purposes, an ID code which may be encrypted is transmitted with each command to prevent hacking and interference with the display and functioning of clock 30. The digits of clock 30 also have built-in numerical on-and off-delays so the transmission from one number to the next will not leave a “memory” as the incandescent lights turn on or off.

Portable controller 90 functions to send signals to wireless communicator 80 in response to inputs from an individual on the field of play who is holding controller 90. Thus, as described below, it transmits timeout duration numbers to wireless communicator 80 in clock box 20 for entry in clock 30, causes clearing of one or more components of board 10, starts and stops clock 30 and turns the various components of board 10 on and off. A Pac-Tec SS-T-HPLS-9VB chassis having a 4×4 keypad, an internal antenna and a 3-digit display could be used for this purpose, although other similarly functioning units would be equally suitable. Controller 90 may also be a transceiver which receives as well as sends signals.

The use of board 10 in sports agendas creates new and legitimate signage space. Since the countdown clock is likely to be viewed repeatedly by a large number of attendees, it provides a new and legitimate advertising forum for display ads. Display advertising venues existing prior to this invention in sports arenas and stadiums have operated under the premise that the advertising display might catch the attention of attendees accidentally during the progress of the game. For televised events, the greater exposure for such ads is likely to be to those in the broadcast receiving audience and, again, occurs accidentally during the progress of play as television cameras traverse the field of play and the stadium or arena. The value of advertising display space increases in direct proportion to the frequency and length of its direct exposure to an intended audience. When advertising is integrated with the timeout counter, a much higher exposure of ads to both attendees and broadcast recipients is guaranteed for the reasons set forth earlier, making the use and sale of such advertising space highly valuable. The countdown clock will be viewed at least as frequently as the scoreboard, if not more often. In fact, due to the concentrated time periods during which the focus of attention of both attendees and participants in sporting events will be directed towards clock 30, advertising space surrounding focal point is considerably more valuable than advertising space located elsewhere in a sports arena or stadium. As a result, revenue to the sports arena or stadium from sales of advertising space adjacent to clock 30 will be greatly enhanced.

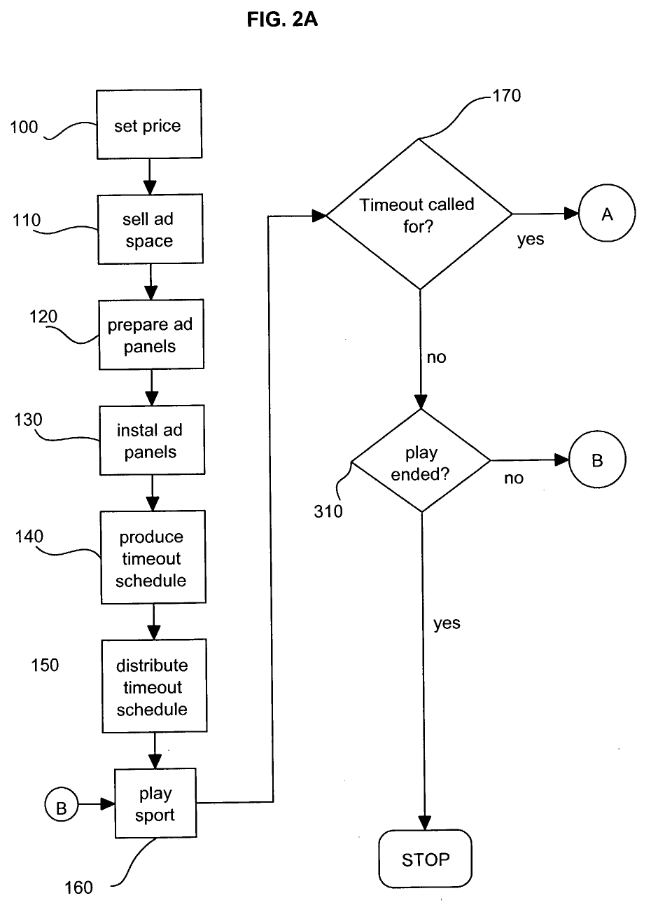

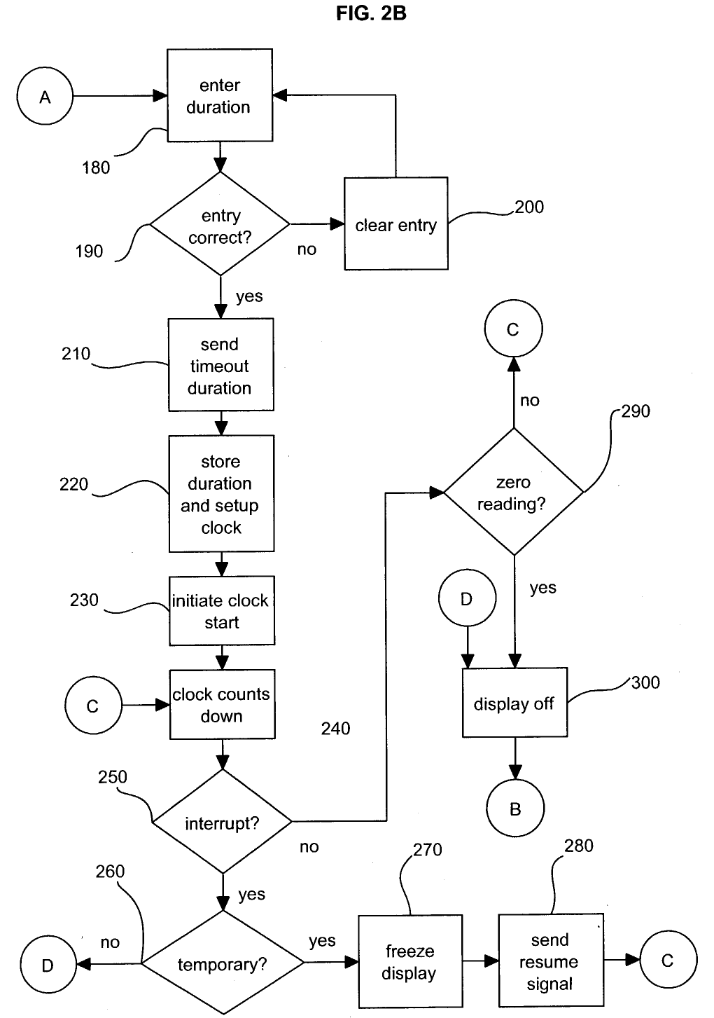

FIGS. 2A and 2B illustrate the steps taken in the method of the invention after installation of board 10 at a sporting arena or stadium which lead to such an increase in revenues. Step 100 requires setting a price for advertising in display ad boxes 60 and 70 for one or more sporting events scheduled to occur in the arena or stadium where board 10 has been mounted. In step 110, advertisers are found who will pay the requested or a negotiated price for display of their advertisements in ad display boxes 60 and 70. This can be accomplished through direct marketing or through use of an advertising intermediary such as an advertising agency. Revenue is likely to be maximized, however, if use of an advertising agency and payment of its commission can be avoided. In step 120, a display is prepared for each of ad display boxes 60 and 70 incorporating each advertiser's advertising material which is installed into the appropriate boxes in board 10 as part of step 130.

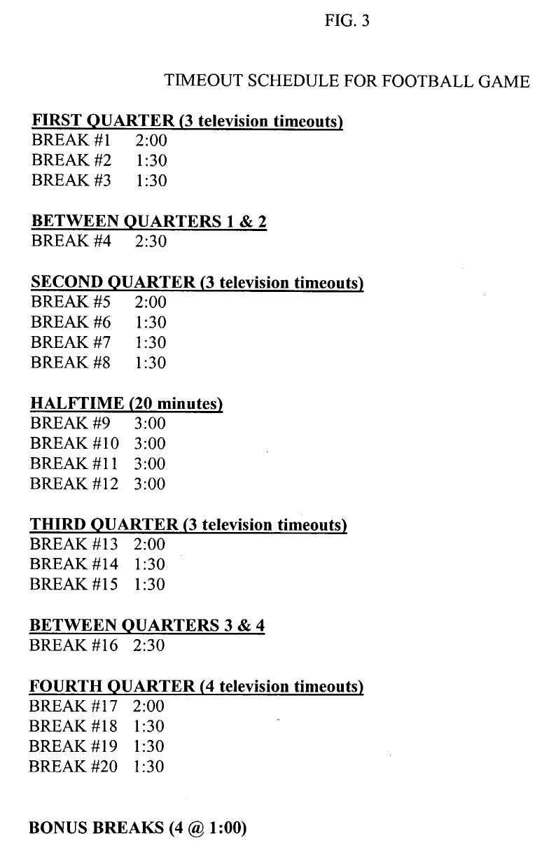

Prior to the start of any given broadcast sporting event, the television production office produces a proposed television timeout schedule for the event in step 140. This schedule is distributed in step 150 to the producer who is onsite at the event, often located in a production trailer near to but outside of the sports arena, and to a person, if there is one, on the playing field who is designated to assist the producer in operating clock 30. Such a schedule is presented in FIG. 3 showing scheduled breaks in a sporting event divided into four quarters where each Break represents a period during which broadcasters insert advertisements of their own choosing into a radio or television broadcast. Bonus breaks occur when the game moves faster than expected so that more time is available for insertion of advertising within the scheduled duration of the event that originally projected. As is evident, the duration of and spacing between breaks varies and may become unpredictable in the event particular breaks are missed due to unexpected occurrences as part of the sporting event such as an unusually long drive by one team that upsets previously scheduled breaks. Typically, the producer will request a timeout after a score or a change in possession, or at a natural break in the action, such as, for example, after a touchdown in a football game. Television usually takes an additional 15 seconds, on average, at the end of each break as a transition period before being ready to broadcast resumed play. Consequently, the timeout clock at the start of a countdown will display the expected timeout duration plus an additional 15 seconds.

Play commences at step 160, and, thereafter, the producer decides whether and when a timeout break needs to be taken at step 170. This can occur either at a natural point in the game such as the end of a quarter, half-time or a team/participant-called timeout or at the option of the producer. Such an elective point could occur if circumstances in the game had made it impossible to take earlier scheduled timeouts or had made them shorter than called for. If a break is desired, the producer verbally announces to those in the production trailer near the stadium that he wants to take a break, usually in 30 seconds, for a specific amount of time, for example, 3 minutes. That desire is transmitted either by means of a microphone transceiver headset or other electronic means from the producer to a person called the Redhat located adjacent to the field of play and also to a production assistant who is similarly situated, both of whom also typically wear microphone transceiver headsets. The Redhat is typically an individual wearing red clothing and a red hat having the task of running out onto the field of play to announce the initiation of a timeout period called for by the onsite television producer. When the Redhat hears that a break is to occur, he runs out on the field of play and attempts to attract the attention of game officials and the official game timekeeper. After the Redhat is recognized, the official game personnel know that a break should be called immediately. Independently of the Redhat, the production assistant, who is in possession of portable controller 90 also hears the producer's announcement and in step 180 enters three digits into controller 90 representing the duration in minutes and seconds of the requested break plus an additional period of time, typically 15 seconds, which is the transition period needed by broadcasters between the termination of advertisements and a return to broadcast of the sporting event. This additional period is variable at the election of the producer. In the example given, the entry would be “3:15”. If an erroneous entry is made, as determined in step 190, a clear button on controller 90 may be activated to clear the entry at step 200 and reentry of the correct number occurs again at step 180. The clear button may also be used to clear the memory of clock 30 after a timeout countdown is complete or in the rare case that the countdown must be terminated prior to a “0:00” reading on clock 30. After correct entry of a timeout duration, the production assistant activates a send function in controller 90 in step 210 in order to transmit the duration of the timeout to wireless communicator 80 in clock box 20. Wireless communicator 80 then stores the timeout duration number and sets up the clock to initially display the selected time duration in minutes and seconds in step 220. The official timekeeper, acting in response to his observance of the Redhat, stops the official game clock. However, the production assistant controls the timeout clock entirely independently of the game clock. In response to the end of a final countdown by seconds transmitted orally from the producer indicating when the producer wants the timeout to actually begin, the production assistant activates a start function on controller 90 in step 230 which sends a signal to communicator 80 instructing it to light the preset numbers of clock 30, of notice area 40 and, electively if they are not already lit, of ad display boxes 60 and 70 and to begin the timeout countdown from the starting number to zero in one second increments in step 240. If a premature interruption of the clock countdown is decided upon at step 250, a further decision must be made at step 260 whether the interruption is temporary or permanent for purposes of the particular timeout. If it is temporary, the production assistant sends a freeze display signal to stop clock 30 while keeping it illuminated at step 270 followed by a resume countdown signal upon receiving an instruction to do so from the producer at step 280, both of which signals are sent from controller 90 to communicator 80, and the process thereafter continues at step 240. If the interruption is meant to terminate the countdown, the production assistant sends a display off command, as explained further below, from controller 90 to communicator 80 to return clock 20 to a standby mode while play of the sport resumes at step 160. If no interruption is called for at step 250, communicator 80 tests for completion of the timeout countdown by looking for a “0:00” reading from clock 30 in step 290. If the countdown is complete, communicator 80 will cause the clock numerals to flash a chosen number of times, such as three times, and will then issue a display off command in step 300 which preferably turns off clock 30 and the illumination for notice area 40 and display ad boxes 60 and 70, returning them all to a standby status, while simultaneously turning on illumination for notice area 50. Alternatively, the display ad boxes could remain lit throughout play of the sport without regard to the timeout periods. The display off command may also be entered manually into controller 90 by the producer, the production assistant or another person in the production trailer. In either event, at approximately the same time as clock 30 goes into standby mode, the official game personnel will reengage the official game clock and play will resume at step 160 until the next timeout occurs or play ends, as decided at step 310 after which the process is exited. Again, it is important to realize that timeout clock 30 and the official game clock operate independently from each other.

The system of the invention may also be employed independently from the use of any advertising display boxes since the information which is provided by the clock alone is the focal point of attention of attendees and participants at any sporting event at which it is used. Thus, for a sport having timeout breaks, illumination and countdown of clock 30 would similarly occur under the control of an individual having a remote controller transmitting to the wireless communicator in board 10. If so used, the system would still provide valuable information to attendees and participants and would also increase the revenue of concessionaires at the venue of such sporting events, as described above.

Although various elements in the previously described embodiments of this invention have been disclosed with reference to particular types of materials and particular sequences of steps, it should be understood that the functions performed by these materials may also be performed in appropriate cases by other types of materials and that this invention is not limited by reference to the specific materials disclosed. Furthermore, the process steps disclosed are not the only way in which the function of this invention can be implemented Other embodiments and sequences of steps are possible so long as the overall structure, method and advantages described above are preserved.

What is claimed is:

1. A method for informing attendees and participants at a public sporting event, having both a preset termination point governed by time or events or both and scheduled and unscheduled timeout periods of varying lengths for broadcast breaks, of the duration and status of each timeout period and for increasing the revenue derived from each such sporting event wherein a board including an unilluminated countdown clock capable of a controlled, illuminated display of time in minutes and seconds and counting down to zero by seconds, at least one unilluminated advertising display box capable of controlled illumination and a wireless communicator capable of storing information and controlling the clock and the display box is prominently mounted at the venue of the sporting event, and wherein further the wireless controller is responsive to signals sent to it by a multi-function remote controller having numerical entry and multiple function entry capability which entries are made by a designated individual and are transmitted to the wireless communicator, comprising the steps of:
marketing advertising to be placed in each advertising display box prior to initiation of play of the sport;
installing the advertising into each advertising display box prior to initiation of play of the sport;
producing a list of scheduled timeouts to be taken at the sporting event prior to initiation of play of the sport;
distributing the list of scheduled timeouts to at least the designated individual;
playing the sport;
deciding whether a scheduled or unscheduled timeout should be requested;
if a timeout is requested,
entering the duration of the timeout period in minutes and seconds plus an additional preselected transition time period into the remote controller;
transmitting the entered minutes and seconds to the wireless communicator;
preparing the clock for display of the entered minutes and seconds;
initiating a start clock function on the remote controller for transmission to the wireless communicator;
displaying an illuminated countdown of time by seconds on the clock while simultaneously illuminating the at least one advertising display box;
ascertaining whether the countdown should be prematurely interrupted; and, if so,
further deciding whether the interruption is temporary or permanent, and, if temporary,
freezing the clock display and later returning to the displaying step at a chosen time;
and, if permanent,
transmitting a display off function from the controller to the wireless communicator and returning to the playing the sport step;
if the countdown is not prematurely interrupted, monitoring the clock for completion of the countdown to zero, and, if zero has not been reached, returning to the displaying step, whereas, if zero has been reached;
sending a display off function signal automatically from the wireless communicator to the clock and each advertising display box; and
returning to the playing the sport step;
returning to the deciding step after the countdown clock completes its countdown to zero if the sports event has not ended
if no timeout is requested, determining whether the preset termination point has been reached, and, if not, returning to the playing step.

2. The method of claim 1 wherein the marketing step further includes setting a price for each advertisement space and selling the use of the advertising space for one or more sporting events to an advertiser.

3. The method of claim 1 wherein the installing step further includes preparing and installing advertisements into each advertising display box.

4. The method of claim 1 wherein the distributing step further includes distributing the timeout schedule people in addition to the designated individual.

5. The method of claim 1 wherein the entering step further includes checking whether the entry into the controller is correct and, if not, correcting it.

6. The method of claim 1 wherein the preparing step further includes storing the entered minutes and seconds in the wireless communicator.

7. The method of claim 1 wherein each advertising display box remains illuminated throughout playing of the sport.

8. The method of claim 1 wherein, after the countdown clock has reached zero, a display off function signal is sent manually from the controller to the wireless communicator.

9. A method for generating additional revenue from the broadcast of the playing at a publicly attended venue of a sporting event having both scheduled and unscheduled timeouts periods of varying lengths for broadcast breaks which periods may occur independently of or concurrently with interruptions inherent in playing of the sport and which periods are requested by an individual, by informing attendees and participants at the sporting event of the duration and status of each timeout period, comprising the steps of:
mounting a board including a timeout countdown clock, at least one advertising display box and a remotely-controlled wireless communicator in a visually prominent location at the venue wherein the clock and the advertising display box are electably illuminated under the control of the communicator and wherein further the functioning of the clock is controlled by the communicator;
selling advertising for placement in the at least one advertising display box;
installing the advertising in the at least one advertising display box;
requesting timeouts after playing of the sport commences and until it terminates;
sending a signal to the communicator from a remote controller in response to each such request to cause the clock to be illuminated during the requested timeout period and to display a countdown to zero in minutes and seconds equal to the length of the timeout requested and, further, to cause the at least one advertising display box to be illuminated for the duration of the timeout period.

10. The method of claim 9 wherein the at least one advertising display box remains illuminated throughout the playing of the sport.

11. A method for informing attendees and participants at a publicly attended venue of a sporting event, having both scheduled and unscheduled timeout periods of varying lengths for broadcast breaks which periods may occur independently of or concurrently with interruptions inherent in playing of the sport and which periods are requested by an individual, of the duration and status of each timeout period, comprising the steps of:
mounting a board including a timeout countdown clock and a remotely-controlled wireless communicator in a visually prominent location at the venue wherein the clock is electably illuminated under the control of the communicator and wherein further the functioning of the clock is controlled by the communicator;
requesting timeouts after playing of the sport commences and until it terminates; and
sending a signal to the communicator from a remote controller in response to each such request to cause the clock to be illuminated during the requested timeout period and to display a countdown to zero in minutes and seconds equal to the length of the timeout requested.
